(19) United States
(12) Patent Application Publication
(10) Pub. No.: US 2012/0111006 A1
(43) Pub. Date: May 10, 2012

(54) SOLAR ENERGY TRANSFER AND STORAGE APPARATUS

(75) Inventor: John Varga, West Yorkshire (GB)

(73) Assignee: CARDING SPECIALISTS (CANADA) LIMITED, West Yorkshire (GB)

(21) Appl. No.: 13/263,684

(22) PCT Filed: Mar. 30, 2010
(86) PCT No.: PCT/GB2010/050536

§ 371 Date: Dec. 6, 2011

(30) Foreign Application Priority Data
Apr. 9, 2009 (GB) 0906173.0
Jun. 18, 2009 (GB) 0910539.6

(51) Int. Cl. F03G 6/06; F24J 2/38; F24J 2/24; F24J 2/08; F24J 2/04; F24J 2/34

(52) U.S. Cl. 60/641.15; 126/634; 126/617; 126/658; 126/698; 126/600; 126/620; 126/646

(57) ABSTRACT

Apparatus to collect solar radiation using a series of lenses or mirrors that concentrate the solar energy onto targets. A gaseous working fluid flowing through the targets is heated and optionally supplied to a heat store having an internal walled labyrinth of a suitable material to store heat energy. A heat exchanger, turbine and electricity generator are coupled to the collection and storage apparatus so as to provide a power plant for the conversion of solar energy to electricity.

The present invention relates to apparatus and a method to collect and transfer solar energy, and in particular, although not exclusively, to power generation apparatus that utilises solar radiation as an energy source and a gas phase heat transfer medium such that heat energy can be both stored and extracted from the apparatus for power generation.

The supply of power or energy in the form of electricity typically requires an energy source which may be subsequently converted and/or supplied as electricity. Traditionally, fossil fuels have been used as a source of energy to drive the turbines for electricity generation. As natural resources are diminished and in the face of climate change, renewable energy sources have been investigated for power and electricity generation. In particular, solar energy has received reasonable attention as an alternative energy source to conventional fossil fuels.

Solar energy collection devices are well established and may be categorised according to two types. Non-concentrating collectors receive the solar radiation directly, as parallel rays of radiation. Such devices typically comprise a solar panel, or array of photovoltaic cells that may be heated and configured to transmit and store the solar radiation. A further type of solar collector is referred to as a concentrating type which reflects or refracts the radiation using lenses or mirror assemblies so as to concentrate the rays onto a target as a more focused solar footprint.

WO 2009/147651 discloses a solar energy generator system for concentrating solar rays for use in a thermodynamic cycle that utilises a gas or steam cycle and a turbine to generate electricity. The solar-ray concentrating system comprises a plurality of concentrating mirrors that act to reflect the radiation towards a suitable absorption and an accumulation body.

US 2009/0308072 discloses a modified Brayton cycle engine that utilises a working fluid heated by solar radiation. In particular, a metal hydride material within a storage unit is heated and hydrogen driven from the hydride material is recombined with the material at a controlled rate in an exothermic reaction for heating a compressible Brayton working fluid for subsequent driving of a turbine coupled to an electric generator.

WO 2010/019990 discloses a solar energy and power generation system. The power generation system comprises a closed working fluid having a super heater, a turbine, a condenser, a subcooler, a receiver and a pump. The working fluid is separated into first and second parallel streams. A solar energy collection system is configured to heat the working fluid by a heat exchanger in both the first and second streams. The first and second fluid streams are then combined, super heated and transferred to the turbine.

WO 2010/021706 discloses a steam based electric power plant operable from renewable geothermal, wind and solar energy sources. Wind or solar power is converted to hydrogen in an electrolysis unit. The generated hydrogen is then fed to a boiler for supplying heat energy to a turbine and generator.

WO 2009/129166 discloses a solar thermal power plant comprising a steam generator and a turbine. Water is converted to steam using solar energy. A super heater then heats the steam from an evaporator to provide super heated steam that is supplied to the turbine.

However, conventional solar energy based power generation systems have a number of disadvantages including in particular the efficiency of operation by which solar energy is captured and harnessed for power generation. Additionally, conventional systems are also limited due primarily to an insufficient capacity to store the captured solar energy. Their use is typically restricted to hot climates and there is a continual need to recharge the limited energy storage device which may result in power or electricity being unavailable during poor or inclement weather conditions.

Moreover, conventional systems that employ a liquid phase or non-gaseous phase working fluid as the thermal vector are restricted inherently to a limiting operational output temperature. As will be appreciated, a number of different types of turbine are used in power generation with varying efficiency. Water based supercritical working fluid turbines are commonly regarded as the most efficient, necessitating working fluid temperatures of around 400° C. with capacity to operate up to 700° C.

There is therefore a need for better apparatus and methods for power generation utilising renewable energy sources that address the above problems.

Accordingly, the inventors provide a solar energy based power generator system that efficiently converts solar energy to heat energy that may be stored conveniently and subsequently converted to electrical energy. The system comprises an array of lenses or mirrors to harness and concentrate solar energy onto a target within a gas phase working fluid cycle that may be coupled to a heat energy storage device. A suitable heat exchanger and turbine arrangement is coupled to the fluid cycle and/or heat storage device to provide on-demand supply of electricity both during and optionally between solar energy collection periods.

According to a first aspect of the present invention there is provided the solar energy collection apparatus comprising: a plurality of lenses and/or mirrors to receive and concentrate solar radiation; a plurality of targets to respectively receive the concentrated solar radiation from each of the lenses and/or mirrors; a conduit network to contain a gas phase working fluid and allow the fluid to flow in contact with the targets such that the working fluid is heated by the targets.

Preferably, the apparatus further comprises a heat storage device connected in fluid communication to the targets by the conduit network to receive the heated working fluid, the storage device comprising a heat storage material to store the heat energy received from the working fluid.

Preferably, the targets comprise a thermally insulated jacket positioned around a portion of the conduit network. Preferably, each target comprises a heat transfer body positioned in the flow path of the working fluid as it flows through the target. Preferably, the heat transfer body comprises a plurality of metal plates or fins. Preferably, the jacket comprises a glass window through which the concentrated solar radiation received from the lens or mirrors may enter the target. Alternatively, the jacket comprises an aperture through which the concentrated solar radiation received from the lens or mirrors may enter the target.

Preferably, the apparatus further comprises means to move the lenses or mirrors to track the position of the sun. More preferably, the apparatus further comprises means to automate movement of the lenses or mirrors to track the motion of the sun. Preferably, the lenses comprise fresnel lenses.

Preferably, the conduit network comprises ceramic and/or clay based piping. Preferably, the heat storage material comprises a mineral based material that may be at least one type of rock such as quarried stone or Basalt. Preferably, the mineral based material is constructed to form a labyrinth of walls within the heat store separated by gas flow channels.

Optionally, the apparatus further comprises at least one gas flow pump and/or fan unit coupled to the conduit network and configured to drive or assist the flow of the working fluid around the conduit network in contact with the targets, the heat exchanger and/or the heat storage device. Optionally, the apparatus further comprises a plurality of valves positioned at the conduit network so as to control the flow of working fluid around the conduit network.

According to second aspect of the present invention there is provided apparatus for converting solar energy to electrical energy comprising: solar energy collection apparatus as described herein; a heat exchanger connected in fluid communication with the conduit network and/or heat storage device to receive the heated working fluid and to transfer the received heat energy; a turbine coupled to the heat exchanger; and an electric generator coupled to the turbine to generate electricity.

Preferably, the working fluid of the heat exchanger is water and steam, including in particular supercritical water. In particular, the gaseous phase working fluid within the conduit network of the collection apparatus is capable of being heated to high temperatures above 400° C. and in particular up to around 700° C., the latter being the recognised maximum operational temperature of a turbine. Preferably, the working fluid of the present collection apparatus is air, and in particular atmospheric air comprising a ground-level air composition.

According to a third aspect of the present invention there is provided a method of collecting solar energy comprising: receiving and concentrating solar radiation using a plurality of lenses and/or mirrors; receiving the concentrated solar energy from each lens and/or mirror at a plurality of targets; allowing a gas phase working fluid to flow in contact with the targets using a conduit network so as to heat the working fluid.

Preferably, the method further comprises storing heat energy acquired by the working fluid in a heat storage device connected in fluid communication to the targets, the heat storage device comprising a heat storage material.

According to a fourth aspect of the present invention there is provided a method of converting solar energy to electrical energy comprising: collecting solar energy as described herein; transferring the heated working fluid from the conduit network and/or the heat storage device to a heat exchanger; driving a turbine using a working fluid of the heat exchanger that has been heated by the conduit network and/or heat energy from the heat storage device; generating electricity via an electric generator coupled to the turbine.

According to one embodiment there is provided a heat store comprising: a housing having exterior walls that are configured to be thermally insulating, the walls defining an internal cavity; a plurality of internal walls extending within the cavity, the walls comprising stones; wherein the walls of stones are arranged in rows with channels created between the rows through which a heat transfer medium is capable of flowing; an inlet for the heat transfer medium positioned towards each end of each channel and; an outlet at the housing to allow the heat transfer medium out of the internal cavity; wherein the heat transfer medium is supplied to the cavity via the inlets and flows through the channels to permeate the walls in contact with the stones and to exit the cavity via the outlet having transferred heat energy to the stones within the cavity.

Optionally, the means to direct the solar radiation on to the targets comprises at least one minor, including in particular a trough, parabolic, round or rectangular minor.

Preferably, the apparatus comprises mechanical movement means connected to each lens and/or mirror and/or target to change the relative position of the lens, minor and/or target. In particular, the targets may be configured to rotate in a lateral direction (East to West). Additionally, the lens or minor may be configured to mechanically pivot over two axes (East to West and North to South) so as to track the position of the sun both annually and diurnally to continually focus the solar radiation onto the targets.

Preferably, the apparatus comprises a plurality of working fluid conduits formed as circulation loops connected to a single heat store or a plurality of heat stores. Each circulation loop may comprise a plurality of target chambers to receive solar radiation and to heat the fluid passing through the circuit. Each circulation loop may comprise the same or a different arrangement of lenses and/or minors.

Preferably, the heat exchanger is a counter-flow heat exchanger in that water from an input flows to the heat exchanger output and is converted to steam in an opposite direction of the supply of hot air from the heat store to the heat exchanger.

Preferably, the heat exchanger and turbine are configured to operate using supercritical water that is in turn heated directly by the gas phase working fluid which is heated by the targets, in turn heated by the solar radiation. The present invention may comprise a plurality of heat exchanger turbine systems that may be coupled directly to the conduit network or where the collection apparatus comprises a suitable heat store, to the heat store.

Where the present invention does not comprise a heat store within the working fluid network, the heat exchanger may be coupled to and heated by conventional fossil fuel sources so as to provide continuous power on-demand in the event of insufficient sunlight.

A specific implementation of the present invention will now be described by way of example only and with reference to the accompanying drawings in which:

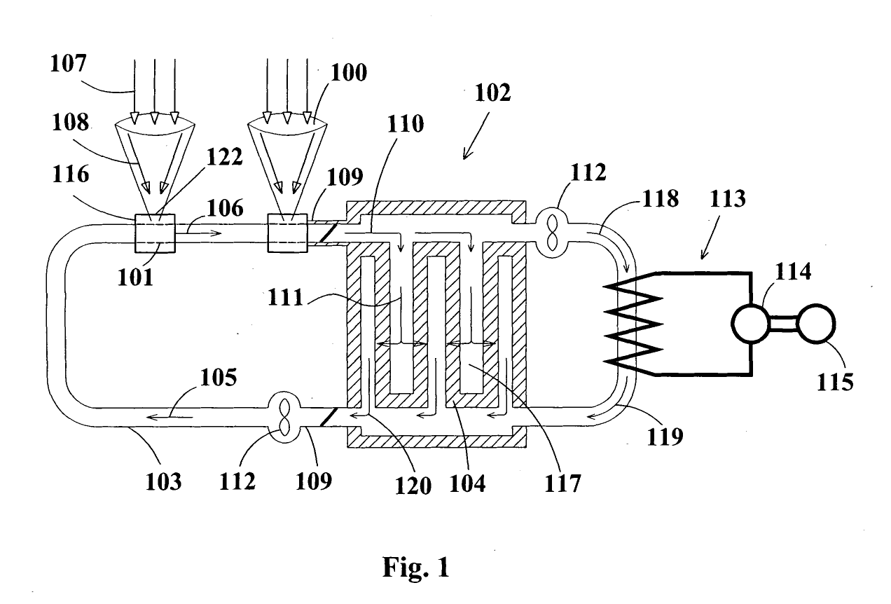

FIG. 1 is a schematic illustration of the solar energy collection and storage apparatus coupled to a heat exchanger, turbine and electric generator according to a specific implementation of the present invention;

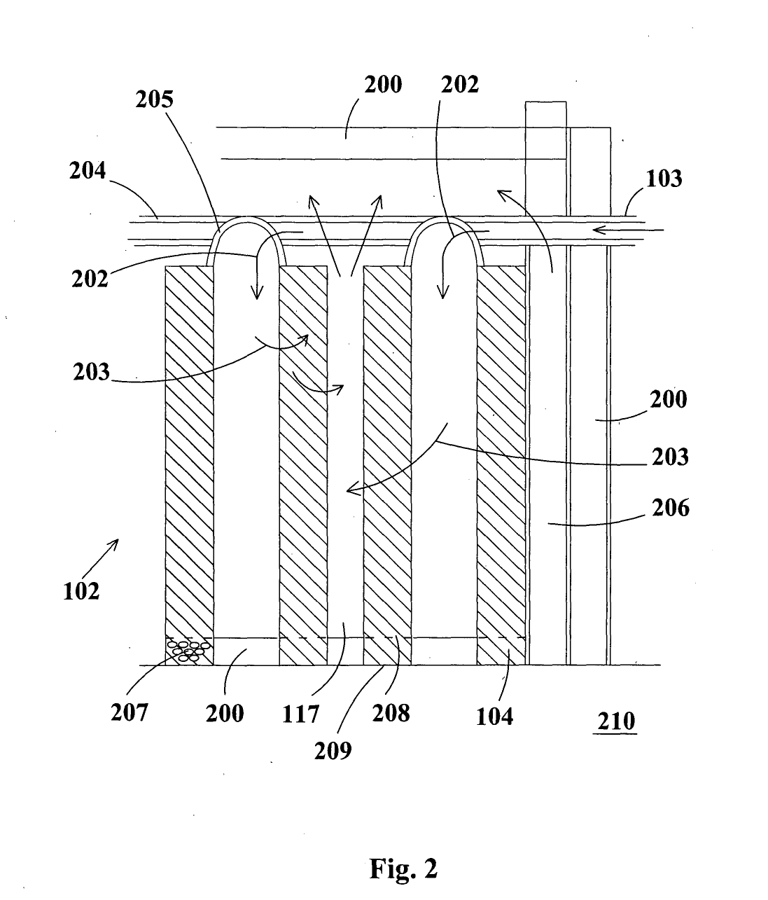

FIG. 2 is a cross sectional side view of a part of the heat store of FIG. 1;

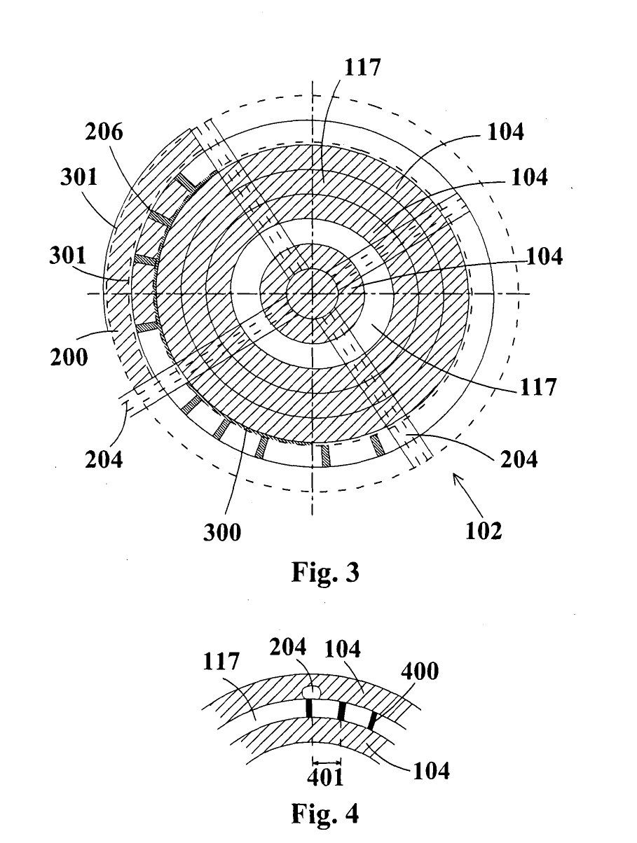

FIG. 3 is a cross sectional plan view of the heat store of FIG. 2;

FIG. 4 is a cross sectional plan view of a part of the heat store of FIG. 3;

FIG. 5 is a side elevation view of a section of the internal heat store walls separated by a support column;

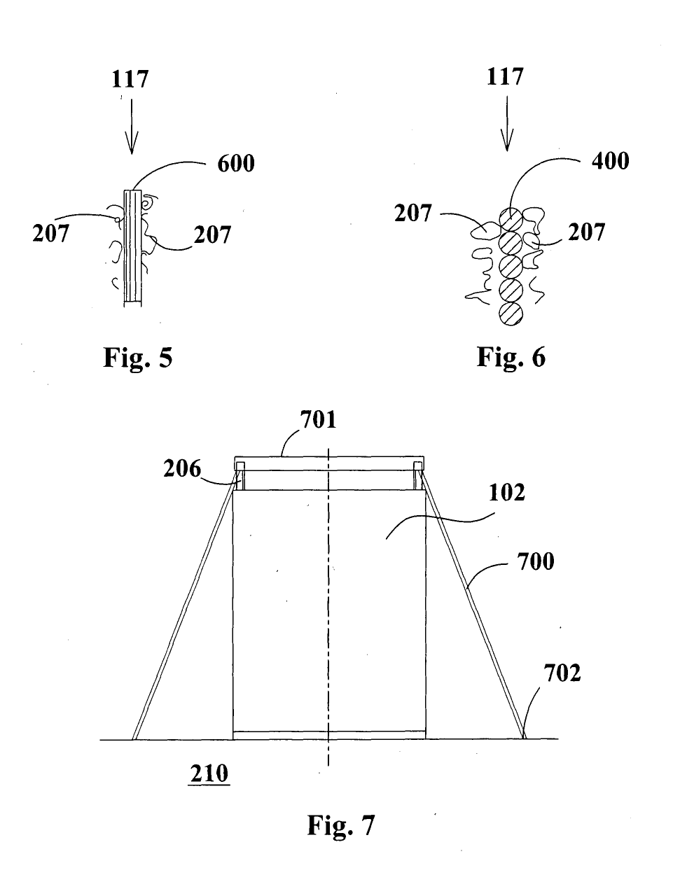

FIG. 6 is a side elevation view of a section of the internal heat store walls separated by a stack of support discs;

FIG. 7 is a schematic side elevation view of the heat store of FIG. 3;

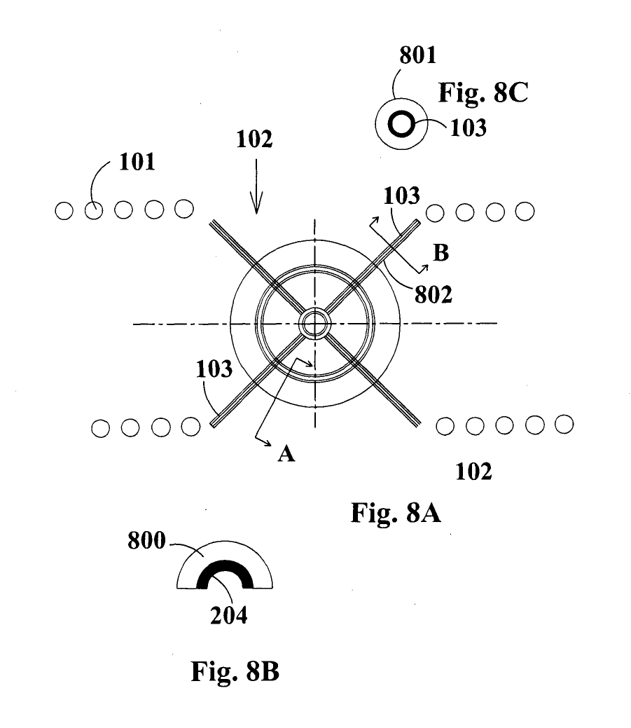

FIG. 8A illustrates schematically a plan view of the heat store of FIG. 2 coupled in fluid communication with a plurality of solar energy targets;

FIG. 8B is a cross section through A-A of FIG. 8A;

FIG. 8C is a cross section through B-B of FIG. 8A;

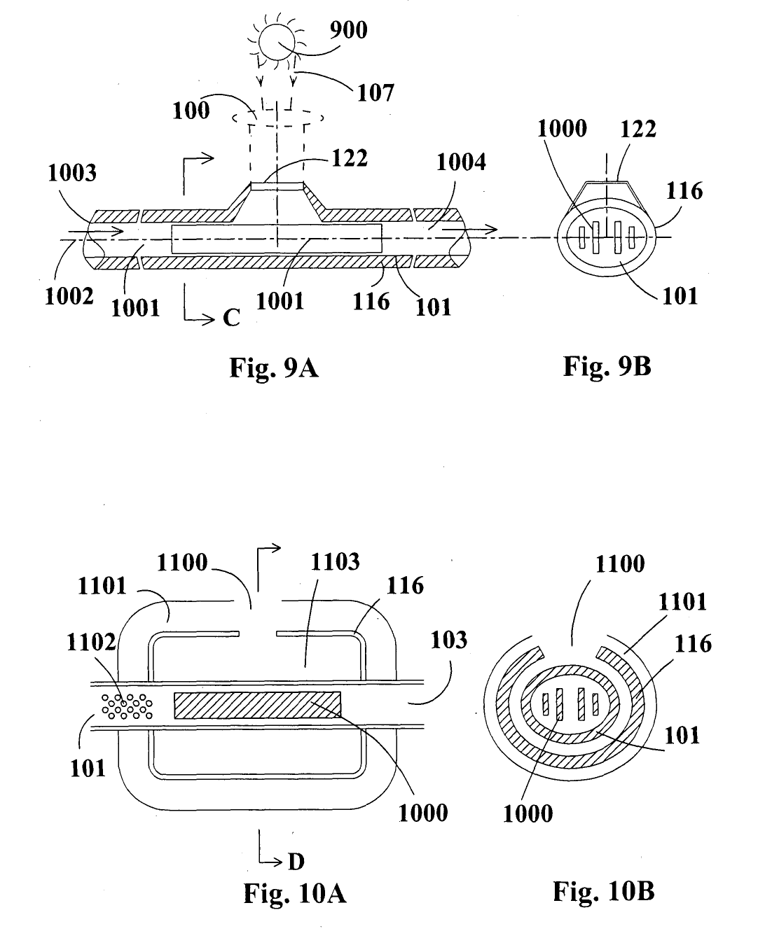

FIG. 9A illustrates schematically a target chamber having a window to receive solar radiation and a radiation transfer plate housed within the target chamber according to a specific implementation of the present invention;

FIG. 9B is a cross section through C-C of FIG. 9A;

FIG. 10A is a further illustration of a cross sectional side view of the target chamber according to a further embodiment comprising an aperture in the target chamber jacket;

FIG. 10B is a cross section through D-D of FIG. 10A;

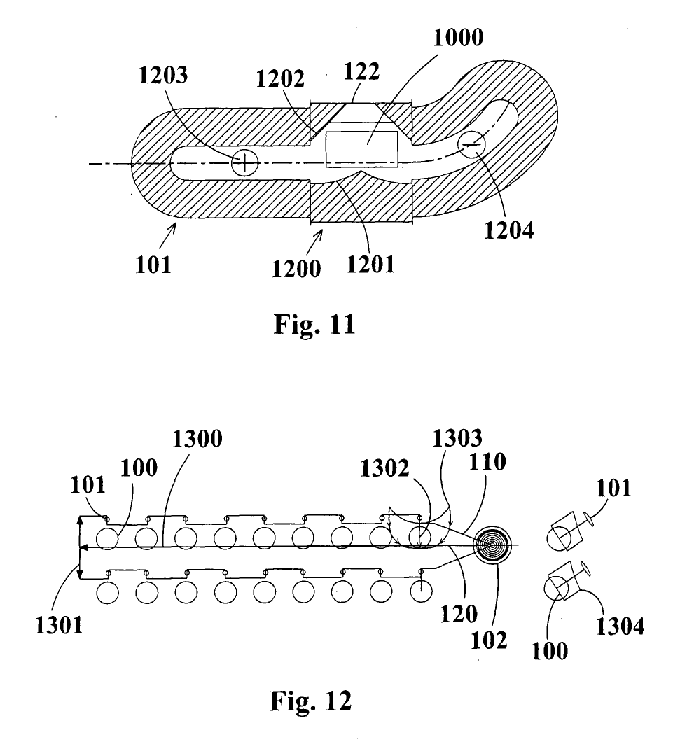

FIG. 11 is a cross sectional side elevation view of a further specific implementation of the solar radiation target that receives solar radiation from the lens;

FIG. 12 illustrates schematically an array of lenses and associated targets coupled to a heat store in fluid communication via a conduit network enabling the transfer of a gas phase working fluid;

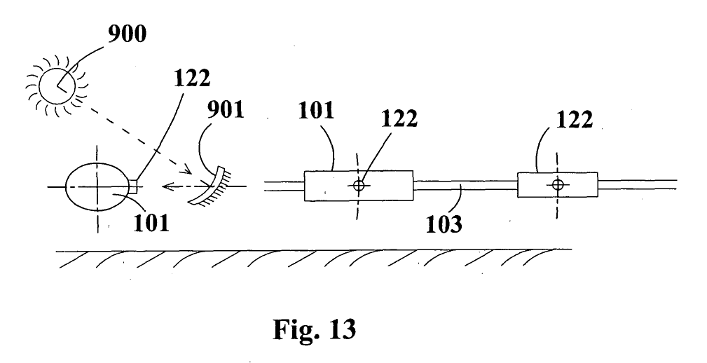

FIG. 13 illustrates a further embodiment in which the lenses are replaced or supplemented by mirrors for concentrating the solar radiation onto the target;

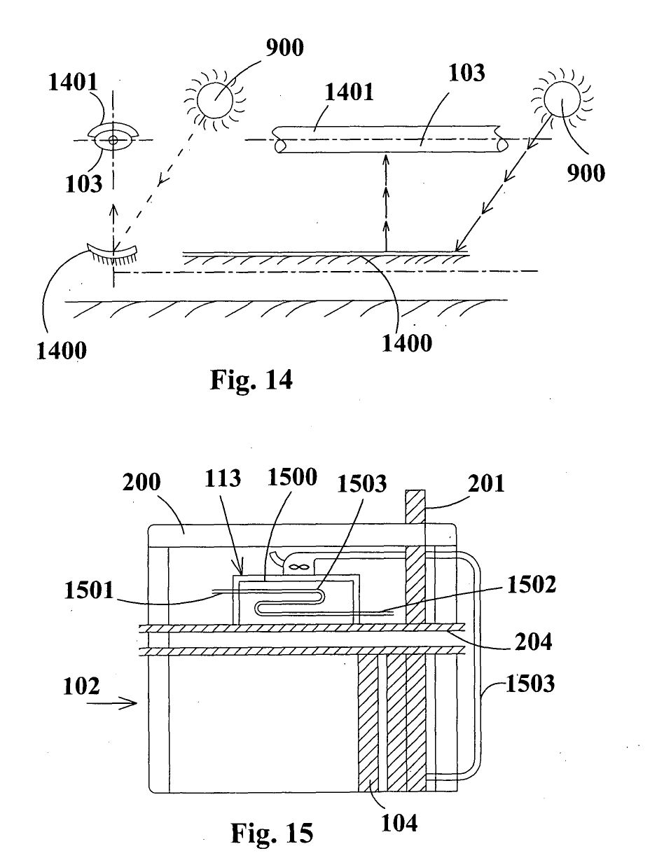

FIG. 14 illustrates schematically a further embodiment comprising trough mirrors arranged below the conduit network for concentrating the solar radiation directly onto the conduit network piping;

FIG. 15 illustrates schematically a cross sectional side view of a part of the heat store of FIG. 2 coupled to a heat exchanger; and

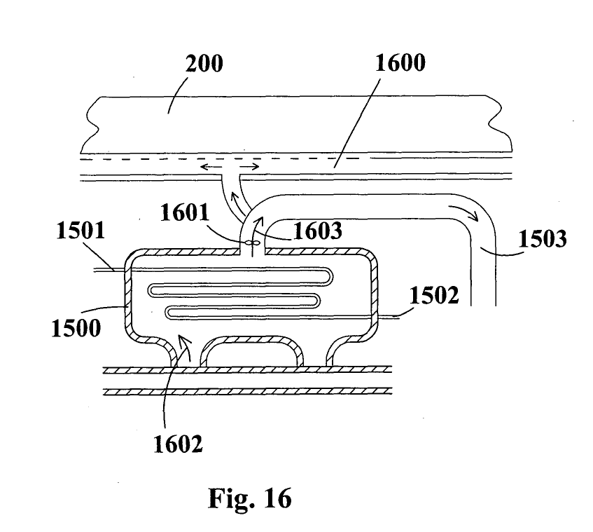

FIG. 16 is a further illustration of the heat exchanger of FIG. 15.

Referring to FIG. 1, the solar energy collection and storage apparatus comprises a plurality of lenses 100 to concentrate solar radiation 108 towards a plurality of respective targets 101. Each target 101 is coupled in fluid communication to a heat store 102 via a conduit network 103 formed as piping. Piping 103 is capable of withstanding extreme high temperatures of the order of 600° C. and comprises a suitable material being ceramic or a clay based material.

The energy collection and storage apparatus is coupled to a heat exchanger 113, a turbine 114 and an electric generator 115 so as to provide apparatus for converting solar energy to electrical energy.

Each target 101 comprises a surrounding jacket 116 that thermally insulates a relatively small region of the conduit network 103. A window 122 is provided at a region of the jacket 116 and is formed from a suitable glass or other low absorption material configured to allow transmission of the concentrated solar rays 108 received from each lens 100 configured to direct solar radiation 107 from the sun onto each target 101. In particular, window 122 is configured to prevent or inhibit re-emission of solar radiation in the form of long wave radiation resultant from the heated target that receives the relative shorter wave solar radiation.

The heat store 102 is positioned downstream of the targets 101. Heat store 102 comprises a plurality of internal walls 104 formed from a suitable heat storage material such as rock, stone or a man-made/synthetic material configured to withstand high temperatures of the order of 600° C. Walls 104 are separated by fluid flow channels 117 so as to form a walled labyrinth structure internally within the body of the heat store 102. Heat store 102 is positioned upstream and in fluid communication with a heat exchanger 113 that is in turn, coupled in fluid communication with the turbine 114 and electricity generator 115.

In use, solar radiation 107 is concentrated by lenses 100 and focused towards targets 101 through each window 122 so as to heat a gas phase working fluid 105 flowing through the conduit network 103. The working fluid flows 106 from the targets 101 into the heat store 110 through suitable control valve 109. The heated working fluid then flows 111 through the mineral walls 104 so as to transfer heat to the heat store 102. The cooled air 120 then flows back into the conduit network 103 via suitable control valves 109.

When required to generate electricity, the heat within store 102 is extracted by the flow 118 of the working fluid being controlled by a suitable pump or fan 112 positioned between the heat exchanger 113 and heat store 102. Heat is then transferred from the working fluid 118 via heat exchanger 113 to drive turbine 114 which converts the heat energy to rotational energy which in turn is converted to electrical energy via generator 115. The lower temperature working fluid then flows 119 back into the heat store 102 and/or into the conduit network 103 via control pumps or fans 112 so as to be reheated at target regions 101.

Referring to FIG. 2, each substantially vertical stone wall 104 may be constructed from two different types of material so as to partition each wall centrally in the vertical plane to define a high temperature side 208 and a lower temperature side 209. The high temperature side 208 comprises Basalt whilst the low temperature half 209 may be formed from non-specific rock 207.

The labyrinth of stone walls 104 are encased within suitable thermal insulation 200 of the appropriate thickness as will be appreciated by those skilled in the art.

Insulation 200 may comprise rock wool or fibreglass. Insulation 200 is also provided at the bottom of the working fluid flow channels 117 so as to insulate the heat store 102 from the ground below 210.

Referring to FIGS. 2 and 3, in order to provide structural support for the rock labyrinth 104, steel support columns 206 are arranged around the perimeter of the outermost wall 104. The outermost wall is also supported by suitable gabion cages 300. The outermost thermal insulation 200 surrounds the steel support columns 206 and is itself contained within an inner and outer steel net 301.

In use, the heated gaseous working fluid flows into the heat store 102 via piping 103 and into the fluid flow channels 117 extending between the rock walls 104. The heated gas then percolates through the hot side 208 of the stone wall so as to transfer heat energy to the mineral. It continues to percolate through the second side 209 into a neighbouring flow channel 117 to be subsequently recycled 120 into the conduit network 103 for reheating at targets 101 to continue the cycle. The gas flow piping 204 within the heat store 102 may be the same or composed of a different material to that of piping 103. Suitable vents and/or diverters 205 are provided within piping 204 so as to direct the gas flow 202 into the labyrinth of channels 117 and ultimately to flow 203 through the stone walls 104.

Referring to FIG. 4, the labyrinth of stone walls 104 is supported internally within the store 102 via intermediate support struts 400 configured to bridge the gap between opposing faces of walls 104 that define the gas flow channels 117. Support struts 400 are separated from one another by a distance 401 responding to approximately half the diameter of each individual rock 207 of wall 104.

FIG. 5 illustrates a side elevation view of the support struts 400 of FIG. 4 nestled between the rocks 207 of opposing walls 104. FIG. 6 illustrates a further embodiment in which support between walls 104 is provided by a column of discs 600 stacked on top of one another within channel 117. Each disc may be secured to its neighbour via mechanical fixings, formed integrally or non-integrally with the discs, including preformed clips or a mortar or cement based material. Similarly, each disc may be secured to the opposing walls 104 by a mortar or cement based material. According to the specific implementation, support struts 400, 600 are formed from a ceramic or clay based material.

Referring to FIG. 7, lateral support for the heat store 102 is provided by stanchions or cabling attached to the uppermost region of each outermost steel support column 206 and a suitable anchor position 702 at ground level 210.

A cross strut or cable 701 extends between adjacent steel supports 206 so as to provide a rigid support frame for the heat store 102. According to a specific implementation, store 102 may be 13 m in diameter and approximately 9 m high and is configured to contain approximately 1,000 tonnes of rock.

Referring to FIGS. 8A to 8C, piping 103 is insulated over its perimeter by suitable insulation material optionally being rock wool or fibreglass of the appropriate thickness. Similarly, piping 204 within heat store 102 is also insulated by the same or a different insulation material 800. Accordingly, thermal heat loss from the working fluid is minimised so as to increase the efficiency of the collection and storage apparatus so as to optimise efficiency of the system and process for generating electricity from solar energy. The present invention is suitable for use with a plurality of targets 101 arranged in series as a set of targets positioned upstream and in fluid communication with the heat store 102. According to the specific implementation, heat store 102 comprises four inlet conduits 802 each connecting a respective series of targets 101 to the internal chamber of heat store 102. Accordingly, heat store 102 comprises one or a plurality of outlets so as to recirculate the working fluid to each series of targets 101 upstream of the store 102.

Referring to FIGS. 9A to 9B, each target 101 comprises a thermal jacket 116 surrounding a region of piping 103. A plurality of thermal conducting plates 1000 extend longitudinally within the inner chamber 1001 of target 101 so as to extend axially along the length of conduit 103. Plates 1000 are positioned side-by-side so as to leave a small gap between opposed faces to allow the passage of the gaseous working fluid as it flows 1002 from the upstream position 1003 to a downstream position 1004 relative to the target 101 and ultimately into the heat store 102. Solar radiation 107 from the sun 900 is concentrated via lens 100 onto window 122 formed in the thermal jacket 116. The concentrated radiation 108 is received by the thermal transfer plates 1000 that increase in temperature in response to exposure to the solar radiation. Gaseous working fluid 102 flowing into contact with the exposed surfaces of the plates 1000 is in turn heated. This heat energy is then transferred to the heat storage material 207 of the heat store walls 104.

FIGS. 10A and 10B illustrate a further specific implementation of the present invention. An aperture 1100 is provided at thermal jacket 116 such that the concentrated radiation 108 passes directly into the internal jacket chamber 1103 to be received at heat transfer plates 1000 via further apertures 1102 formed in the piping 103 at the region of the target. The inventors have found that heat loss due to convection through the aperture 1100 is relatively small and may be approximately equal to the thermal absorption of the material of window 122. A thermal insulation material 1101 is positioned externally around jacket 116 so as to minimise heat loss at the region of the target and to ensure efficient heat transfer from plates 1000 to the working fluid.

FIG. 11 provides a further illustration of target 101. A central region 1200 of target 101 is shaped and dimensioned so as to create turbulence as the working fluid flows through the target from 1203 to 1204. In particular, a raised deflecting portion 1201 directs the working fluid upwardly towards sloping walls 1202 extending from window 122 towards the heat transfer plates 1000. Accordingly, the exposure time of the working fluid at the region of the plates 1000 is increased so as to maximise heat transfer.

FIG. 12 illustrates schematically two parallel series of nine individual lens 100 and target 101 units. Each target 101 of each series forms part of the fluid flow cycle through the heat store 102. An outlet conduit 1300 extends from heat store 102 and is then split into separate conduits 1301 to provide a supply of working fluid to the start of each target series. The fluid then flows 110 into heat store 102 from the last target of the series and having transferred thermal energy to the heat store exits at 120 to flow along conduit 1300.

Suitable means 1302 are provided to automatically move lens 100 over a predetermined grid space 1303 to track the position of the sun, both annually and diurnally. Each lens 100 via means 1302 is also configured to move laterally about grid space 1304 in response to the movement of the sun and to ensure solar radiation is continually focused towards target 101. The movement of lens 100 over space 1303 and 1304 occurs over three planes according to X, Y and Z axes. Accordingly, the centre of each lens is capable of movement over an imaginary section of a surface of sphere such that the centre of each lens is continually orientated towards the target with the separation distance between lens and target being substantially equal to the focal length of the lens.

FIG. 13 illustrates a further implementation comprising a plurality of mirrors 901 configured to concentrate the solar radiation received from the sun 900 towards target window 122. Accordingly, each target 102 comprises an associated mirror 901 instead of or in addition to lens 100.

FIG. 14 illustrates a further alternative embodiment comprising a trough mirror 1400 positioned below a region of conduit 103 so as to direct solar radiation onto the lower half of the conduit 103. Thermal insulation 1401 is positioned over an upper half of the conduit 103 such that the concentrated radiation 103 from mirror 1400 is incident directly upon conduit 103.

Referring to FIGS. 15 and 16, heat store 102 is coupled to a heat exchanger 113. The heat exchanger working fluid 1503 cycles through the heat exchanger body 1500 from an inlet 1502 to an outlet 1501. Outlet 1501 is coupled to the input end of a turbine 114 and inlet 1502 is coupled to the output end of the turbine 114. Heat exchanger 113 is coupled in fluid communication with the working fluid of the heat store 102 such that the heated fluid 1602 (of heat store 102) flows into the body of the heat exchanger 1500 to heat the heat exchanger working fluid 1503 between inlet 1502 and outlet 1501. The cooled working fluid 1603 of the heat store 102 then flows out of the heat exchanger body 1500 and is re-circulated 1503 into a cavity region 1600 between the heat store internal chamber and the outermost thermal insulation 200. Accordingly, this cavity region 1600 provides a further cooler thermal layer around the heat store to reduce heat loss from the walled labyrinth 104.

1. Solar energy collection apparatus comprising:
a plurality of lenses and/or mirrors to receive and concentrate solar radiation;
a plurality of targets to respectively receive the concentrated solar radiation from each of the lenses and/or mirrors;
a conduit network to contain a gas phase working fluid and allow the fluid to flow in contact with the targets such that the working fluid is heated by the targets.

2. The apparatus as claimed in claim 1 further comprising: a heat storage device connected in fluid communication to the targets by the conduit network to receive the heated working fluid, the storage device comprising a heat storage material to store the heat energy received from the working fluid.

3. The apparatus as claimed in claim 1 wherein the targets comprise a thermally insulated jacket positioned around a portion of the conduit network.

4. The apparatus as claimed in claim 3 wherein each target comprises a heat transfer body positioned in the flow path of the working fluid as it flow through the target.

5. The apparatus as claimed in claim 4 wherein the heat transfer body comprises a plurality of metal plates or fins.

6. The apparatus as claimed in claim 3 wherein the jacket comprises a glass window through which the concentrated solar radiation received from the lens may enter the target.

7. The apparatus as claimed in claim 3 wherein the jacket comprises an aperture through which the concentrated solar radiation received from the lens may enter the target.

8. The apparatus as claimed in claim 1 comprising means to move the lenses and/or mirrors to track the position of the sun.

9. The apparatus as claimed in claim 8 comprising means to automate movement of the lenses and/or mirrors to track the motion of the sun.

10. The apparatus as claimed in claim 1 wherein the lenses comprise fresnel lenses,

11. The apparatus as claimed in any preceding claim 1 wherein the conduit network comprises ceramic and/or clay based piping.

12. The apparatus as claimed in claim 2 wherein the heat storage material comprises a mineral based material.

13. The apparatus as claimed in claim 12 wherein the mineral based material comprises at least one type of rock material.

14. The apparatus as claimed in claim 12 wherein the mineral based material is constructed to form a labyrinth of walls separated by gas flow channels.

15. The apparatus as claimed in claim 2, further comprising at least one gas flow pump and/or fan unit coupled to the conduit network and/or the heat storage device and configured to drive or assist the flow of the working fluid around the conduit network.

16. The apparatus as claimed in claim 1 further comprising a plurality of valves positioned at the conduit network so as to control the flow of working fluid around the conduit network.

17. Apparatus for converting solar energy to electrical energy comprising:
solar energy collection apparatus according to claim 1;
a heat exchanger connected in fluid communication with the conduit network to receive the heated working fluid and to transfer the received heat energy;
a turbine coupled to the heat exchanger; and
an electric generator coupled to the turbine to generate electricity.

18. The apparatus as claimed in claim 17 comprising a steam turbine.

19. The apparatus as claimed in claim 17 comprising a water based working fluid heat exchanger,

20. A method of collecting solar energy comprising;
receiving and concentrating solar radiation using a plurality of lenses and/or mirrors;
receiving the concentrated solar energy from each lens or mirror at a plurality of targets;
allowing a gas phase working fluid to flow in contact with the targets using a conduit network so as to heat the working fluid.

21. The method as claimed in claim 20 further comprising:
storing heat energy acquired by the working fluid in a heat storage device connected in fluid communication to the targets, the heat storage device comprising a heat storage material.

22. A method of converting solar energy to electrical energy comprising:
collecting and storing solar energy according to the method of claim 20;
transferring the heated working fluid from the conduit network to a heat exchanger;
driving a turbine using a working fluid of the heat exchanger that has been heated by the heat energy from the conduit network;
generating electricity via an electric generator coupled to the turbine.
